(19) United States
(12) Patent Application Publication
(10) Pub. No.: US 2004/0234692 A1
(43) Pub. Date: Nov. 25, 2004

(54) Device and method for vacuum impregnation

(76) Inventor: Herbert Georg Nopper, Kuppenheim (DE)

Correspondence Address: Stephan A Pendorf, Pendorf & Cutliff, 5111 Memorial Highway, Tampa, FL, 33634-7356, US

(21) Appl. No.: 10/486,259

(22) PCT Filed: Aug. 9, 2002
(86) PCT No.: PCT/EP02/08972

(30) Foreign Application Priority Data
Aug. 9, 2001 (DE) 10139128.5

(51) Int. Cl. B05D 3/00; B05D 7/00

(52) U.S. Cl. 427/294; 427/212

(57) ABSTRACT

A method is described for vacuum impregnation of particulate material in an impregnation installation (16, 16′) which has an impregnation chamber (54, 84) that can be placed under vacuum, an inlet orifice (64, 64′) for transferring the material into the impregnation chamber (54, 84) and an outlet orifice (82, 82′) for transferring the material out of the impregnation installation (16, 16′), with the following method steps

treatment of the material with a substance in order thus to produce a treated material, the sealing characteristics of which in a stuffing screw are improved in comparison with the untreated material,

transport of the treated material by means of a stuffing screw (52) to the inlet orifice (64, 64′),

transfer of the treated material by means of the stuffing screw (52) through the inlet orifice (64, 64′) into the impregnation chamber (54, 84), so that the treated material seals the inlet orifice (64, 64′) during inward transfer,

impregnation of the material in the impregnation chamber (54, 84) with an impregnating agent under reduced pressure,

transport of the impregnated material to the outlet orifice (82, 82′) and

outward transfer of the impregnated material from the impregnation installation (16, 16′) through the outlet orifice (82, 82′), so that the material seals the outlet orifice (82, 82′) during outward transfer.

### FIELD OF THE INVENTION

The invention relates to a method and an installation for vacuum impregnation of particulate material. In this context the term particulate material comprises, for example, vegetable fibre raw materials (shredded straw, wood chips, natural fibres) such as are used, for example, for the production of hardboards, as well as granular or fibrous plastic material that can be used, for example, as filler or woven fabric.

### BACKGROUND OF THE INVENTION

Especially when impregnating chips or fibres of natural raw materials, it has proved advantageous to mix the material to be impregnated with an impregnating agent under vacuum. Specifically, during this operation gas (air) present in the pores of the raw material is pumped off during impregnation (degassing), as a result of which the absorbency of the raw material for impregnating agent is distinctly increased.

A vacuum impregnation method of this type and a corresponding installation is disclosed in DE 199 11 230. In this method, particulate material is transferred through a first lock chamber to which a vacuum can be applied, into an impregnation chamber, and is then transferred through a second lock chamber to which a vacuum can be applied, out of the impregnation chamber. With this method, the impregnating process thus takes place intermittently. During the introduction and removal of the material—during which period the lock chambers are ventilated—the lock chambers are in each case closed off from the impregnation chamber by shut-off elements and a vacuum is then applied to these chambers. The shut-off elements to the impregnation chamber are then opened and the material can be transported into or out of the impregnation chamber. The impregnation chamber thus remains under vacuum throughout the entire process. Only the lock chambers, which are smaller in terms of volume, are alternately ventilated and placed under vacuum.

The pumping-out period and the size of the lock chambers are competing factors which, disadvantageously, cannot simultaneously be reduced as desired. They thus limit the throughput rate of the installation. On the other hand, the installation is comparatively susceptible to malfunction, since the opening and closing shut-off elements are sensitive to impurities, for example through the particulate material introduced. These impurities can cause vacuum leaks, as a result of which, in addition to the throughput rate that is limited in any case, there are also undesired downtimes.

### SUMMARY OF THE INVENTION

The aim of the present invention is, therefore, to provide a method and an installation for vacuum impregnation, which method/installation guarantees greater process reliability and higher efficiency.

In respect of the method, the aim is achieved by a method for vacuum impregnation of particulate material in an impregnation installation which has an impregnation chamber that can be placed under vacuum, an inlet orifice for transferring the material into the impregnation chamber and an outlet orifice for transferring the material out of the impregnation installation, with the following method steps:

treatment of the material with a substance in order thus to produce a treated material, the sealing characteristics of which in a stuffing screw are improved in comparison with the untreated material,

transport of the treated material by means of a stuffing screw to the inlet orifice,

transfer of the treated material by means of the stuffing screw through the inlet orifice into the impregnation chamber, so that the treated material seals the inlet orifice during inward transfer,

impregnation of the material in the impregnation chamber with an impregnating agent under reduced pressure,

transport of the impregnated material to the outlet orifice, and

outward transfer of the impregnated material from the impregnation installation through the outlet orifice, so that the material seals the outlet orifice during outward transfer.

The aim is furthermore achieved by an installation for carrying out the method.

As a result of the design of the method according to the invention, it is ensured that the impregnation chamber is permanently sealed with respect to the surroundings even during inward and/or outward transfer, without the upstream and downstream lock chambers having to be intermittently charged and emptied and, respectively, ventilated and placed under vacuum. Shut-off elements that are susceptible to malfunction between the lock chambers and the impregnation chamber are also dispensed with.

Preferably, the substance with which the material is (pre)treated in order to obtain a treated material with improved sealing characteristics is a liquid impregnating agent (in particular an impregnating solution). This design of the method according to the invention is, of course, particularly advantageous because a substance that in any case would have to be added to the material, at the latest inside the impregnation chamber, is used to improve the sealing characteristics of the material to be impregnated. The use of substances that serve solely for sealing but otherwise are of no significance in the impregnating process is advantageously completely dispensed with.

Treatment of the material then preferably takes place by adding the liquid impregnating agent (the impregnating solution) during transport of the material to the inlet orifice and preferably when compressing the material during transport to the inlet orifice. What is achieved by this means is that a material mixture with a higher density is obtained. Furthermore, the impregnating solution forms an impervious film between the material and the surface of the means for transporting the material. Both effects, the increasing material density and the surface film, improve the sealing characteristics to a decisive extent.

Without the (pre)treatment of the material according to the invention with a substance that improves the sealing characteristics (for example an impregnating agent), satisfactory impregnation results can be achieved only with great difficulty (if at all) when a stuffing screw (inlet screw) is used. Specifically, it has been shown that when particulate untreated material is fed in, and specifically especially when shredded straw, wood chips and natural fibres are fed in, leaks frequently arise that cause the vacuum in the impregnation chamber to collapse; in other words, the untreated material produces a seal with the walls of the stuffing screw to only an inadequate extent. Moreover, wear in a stuffing screw when untreated material is used is particularly high if an attempt is made to produce a material plug that seals well. In this regard see the preamble to the description in DE 44 19 733 A1, in which typical problems when using a stuffing screw are indicated.

In the method according to the invention, a salt solution with a concentration of 25-35% and with a density of 1.1 to 1.2 g/cm³ can, for example, be used as a liquid impregnating agent that also has an advantageous effect on the sealing characteristics of the material to be impregnated. Such a salt solution has a tacky/viscous consistency. The reduced flowability (increased viscosity) of the impregnating solution, on the one hand, and the increased binding effect (“tackiness”) thereof, on the other hand, additionally intensify plug formation by the material. As a result impermeability of the material plug both to a pressure drop (on entry into the impregnation chamber) and also to a rising pressure—in each case considered in the transport direction—is ensured. Moreover, an improved sliding effect between the compressed material and, for example, the inside wall of the stuffing screw can be produced in this way, as a result of which screw wear is reduced.

Finally, if liquid impregnating agent (in particular an impregnating solution) is added thereto during transport to the inlet orifice, the material is already pre-impregnated before it reaches the impregnation chamber. As outlined above, this takes place especially during compression in the stuffing screw, which is to say under pressure, as a result of which the impregnating time in the impregnation chamber is advantageously shortened.

Preferably, in the method according to the invention the material is continuously transferred through the inlet orifice into the impregnation chamber and/or continuously transferred through the outlet orifice out of the impregnation installation.

An installation for applying a vacuum to the impregnation chamber, for example a vacuum pump system, provides the requisite reduced pressure relative to ambient pressure. This is preferably effected by a vacuum that is permanently applied to the impregnation chamber when carrying out the method according to the invention. However, as an alternative the impregnation chamber can also be connected by means of a valve to a device for applying a vacuum to the impregnation chamber only when required, for example when a predetermined maximum pressure value is exceeded, and otherwise can be disconnected therefrom. The valve is then preferably equipped with a corresponding control for pressure-dependant opening or closing of the valve.

The advantages of the preferred method according to the invention and of the preferred installation according to the invention are numerous: for instance, with a continuous material flow it is ensured that the parameters (a) volume flow of the material supplied, (b) gas pressure and (c) moisture level in the impregnation chamber, which are important for vacuum impregnation, are essentially constant. As a result high process reliability is ensured, which, on the one hand, gives rise to a saving in raw materials and energy and, at the same time, uniform absorption of impregnating agent, constant charging of the downstream processing stages, such as, for example, the pre-dryer and pulping material, and thus ultimately makes product sequences with constant properties possible.

Furthermore, it proves advantageous to compress the material not only (by means of the existing stuffing screw) during transport to the inlet orifice, but also during transport to the outlet orifice (for example again by means of a stuffing screw). The density of the particulate material can then be so increased, not only during inward transfer but also during outward transfer, that a plug forms, which as a rule improves the sealing characteristics of the material. The plug develops essentially in the region of the greatest material compression (impervious region), as a result of which the inlet orifice and outlet orifice, respectively, of the impregnation chamber and the impregnation installation, respectively, are simultaneously defined. If, for example, stuffing screws that are conically tapered in the direction of transport are used to compress the material, sealing takes place in the region of the end of the stuffing screw that is in the direction of transport.

In a particularly preferred embodiment of the method and of the installation, the material is compressed during transport to the outlet orifice in order to achieve better sealing at that location as well. With this procedure it is advantageous to collect excess impregnating solution, which is pressed out by the compression, in corresponding equipment and optionally to recycle it for re-use.

The means for transporting the material to the inlet orifice and to the outlet orifice, which are preferably constructed as stuffing screws (hereinafter termed feed screw and discharge screw, respectively) usually have a taper in their external circumference in the direction of transport. When impregnating shredded or chopped straw, the ratio of the cross-section at the inlet side to the cross-section at the outlet side of the feed screw is typically 1.05:1-1.3:1 for a cross-section on the inlet side of, for example, 600 mm. The discharge screw typically has a conicity of 1.1:1-1.4:1 for a cross-section on the inlet side of, for example, 400 mm. The conicity and cross-section data have been indicated by way of example for shredded or chopped straw to which impregnating agent is added during compression in the feed screw. However, they can also differ substantially from these depending on the compressibility and particle size of the material to be impregnated.

As an alternative to a conically tapering stuffing screw, compression of the material can also be achieved by a decreasing pitch of the screw for constant cross-section or by a combination of the two variants. However, a conical construction of the stuffing screws is always more advantageous since, for a given amount to be transported, the cross-section at the output side, at which plug formation essentially takes place, is smaller than in the case of a screw of constant cross-section and thus a smaller cross-sectional area has to be sealed.

Preferably, the installation has means downstream of the feed screw and/or the discharge screw by means of which the material is loosened after inward transfer and outward transfer, respectively.

It is advantageous if, in the method according to the invention, the amount of impregnating agent additionally used upstream of the entry into the impregnation chamber and/or additionally used during impregnation is controlled depending on the amount of the untreated material transported to the inlet orifice, in order to influence the sealing characteristics of the material and/or the impregnation thereof.

The installation according to the invention can be used for the impregnation of a multiplicity of materials. Examples of materials which may be mentioned are:

renewable natural fibre raw materials, for example:

all types of wood, that is to say both hardwoods and softwoods;

bagasse (sugar cane), bamboo, cotton, jute, sisal, hemp, China-grass, cereal straw of all types, rice straw, rice husks, silver grass, elephant grass, giant grass (miscanthus), flax (fibres and shive), coconut, Indian brown hemp, alfa grass, agave fibres, etc.

plastics, for example:

viscose, polystyrene, vinyl polymers, acrylonitrile, polyamides, polyurethanes, polyesters, Perlon, nylon, Kevlar, polyterephthalate, etc.

Within the range of renewable natural raw materials particles that fall under the term “particulate” are, in particular:

OSB (Oriented Strand Board) Chips:

length up to 150 mm, width up to 30 mmm (sic), thickness up to 1 mm;

Chopped Slivers:

Length up to 40 mm, width up to 15 mm, thickness up to 5 mm; bulk density in the range 180-220 kg/m³;

Chippings:

dimensions variable within a wide range; bulk densities of 20-250 kg/m³;

Chopped Straw:

length up to 60 mm, width up to 6 mm, thickness corresponding to the thickness of the stalk;

Separated fibres and fibre bundles of arbitrary length.

The indicated dimensions are to be understood as merely exemplary.

The following materials in particular can be used as liquid impregnating agent or constituent of a liquid impregnating agent:

fireproofing materials; fungicides, biocides, germicides, insect repellents, termite repellents such as, for example, polyboron/disodium octaborate tetrahydrate or cashew nutshell oil/alkylphenol; organic and inorganic silicates; substances to increase or lower the electrical conductivity; antistatic agents; metallising agents; antioxidants; water-repellent agents; agents that increase stability; lacquers; resins; finishes; latexes; setting oils, waxes, paraffins, bitumen; curing agents, buffers and absorbents; odour enhancers; surfactants.

Liquid or aqueous impregnating agents can be used, in particular in the following application forms:

true solutions of liquid or solid substances in a solvent (for example water);

emulsions, dispersions;

inorganic and organic liquids, for example oils.

Preferred fireproofing impregnating agent solutions that can be used in the installation according to the invention are described in WO 97/46635; they include ammonium sulphate, borax and trisodium phosphate, which preferably are dissolved in water. All impregnating agent solutions defined in WO 97/46635 are part of this application by way of reference.

If a liquid impregnating agent, such as is preferred within the framework of the present invention, serves as an agent to improve the sealing characteristics of the material to be impregnated in the stuffing screw, a person skilled in the art can, whilst at all times taking account of the primary purpose of the impregnating agent (for example fireproofing or insect repellent or the like), vary the chemical make-up of the impregnating agent depending on the particular intended use, in order to increase in a desired manner the sealing characteristics of the material to be impregnated.

With regard to the physico-chemical principles, a person skilled in the art will take into account that the sealing characteristics can be influenced (a) by a suitable combination of low molecular weight and higher molecular weight substances (short-chained and long-chained organic compounds), (b) by the use of mixtures of readily soluble and sparingly soluble additives (salts or the like), (c) by adjusting the concentration of the impregnating agent, which, for example, is in aqueous solution, and/or the density and/or viscosity of the corresponding impregnating solution and/or (d) by adding water softening additives.

An impregnating agent used to influence the sealing characteristics can be, for example, (a) an aqueous solution, which contains only a single impregnating agent substance, or can be (b) a mixture of at least two products, such as, for example, a combination of an agent of low viscosity and, in each case, an agent of high viscosity, or contain (c) viscosity regulators, such as, for example, silicates (in particular sodium metasilicate), phosphates, polyboron, acrylates, glycols (polyethylene glycols), glycerol, starches, fatty acids, fatty acid esters, fatty alcohols or the like.

If impregnating agents are used as agents to influence the sealing characteristics, according to a preferred embodiment metering of the impregnating agent from a single reservoir is possible. The impregnating agent preparation can then be fed from the reservoir via separate lines (a) to the stuffing screw (feed screw), which transports the treated material to the inlet orifice, and/or (b) introduced into the impregnation chamber. If a feed is provided both to the feed screw and also to the impregnation chamber, it is possible, as desired, to add the entire amount of impregnating agent to be used to the material to be impregnated upstream of the impregnation chamber (preferably in the stuffing screw) (100% of the impregnating agent to be used is added to the material to be impregnated upstream of the inlet into the impregnation chamber) or it is possible, for example, to add 50 or 60% of the impregnating agent preparation to the material to be impregnated in the stuffing screw, in order to improve the sealing characteristics of said material, and to add the remaining 50 or 40% of the impregnating agent preparation in the impregnation chamber. In this context it is pointed out that even in the case of complete (100%) addition of the impregnating agent to be used to the material to be impregnated upstream of the inlet into the impregnation chamber (preferably within the stuffing screw) very good penetration of the impregnating agent into the material to be impregnated (in particular chippings or fibres) takes place via the vacuum in the downstream impregnation chamber and the associated withdrawal of air from the pores of the material to be impregnated.

According to a further preferred embodiment, it is not a single impregnating agent that is used but two different additives, to which separate feed lines to the impregnation chamber or to the feed screw (or a region upstream of the feed screw through which the material to be impregnated has to pass) are assigned. For example, it is advantageous to add a first additive, which has a high viscosity and is able to disperse uniformly on the surface of the material to be impregnated with the formation of a durable slide film, to the material to be impregnated upstream of the inlet into the impregnation chamber in order thus to improve the sliding properties of the material to be impregnated in the feed screw.

A second additive that, compared with the first additive has a lower viscosity and to which penetration aids such as surfactants, metasilicates and the like are preferably added is then preferably metered into the impregnation chamber. With this procedure the additives can in each case themselves contain impregnating agents, but this does not have to be the case.

In total, an entire range of different combination options is available to the person skilled in the art by means of which the latter can improve the sealing characteristics of the material to be impregnated in the feed screw, without this giving rise to relevant additional costs. In this context those process embodiments are preferred in which a liquid impregnating agent is also used to adjust the sealing characteristics of the material to be impregnated in the feed screw such that these are adequate. The method according to the invention can be used, in particular, for the impregnation of particulate materials consisting of renewable raw materials (in particular straw). It therefore enables the use of stuffing screws, which hitherto have not appeared suitable for relatively dry materials which can be compacted, and thus transported, to only a limited extent (such as, for example, straw).

### BRIEF DESCRIPTION OF THE FIGURES

Further advantageous embodiments of the method according to the invention and of the installation can be seen from the claims and will be explained on the basis of the following examples with reference to the figures.

FIG. 1 shows, diagrammatically, an impregnating plant with an impregnation installation according to the invention;

FIG. 2 shows, diagrammatically, a first illustrative embodiment of the impregnation installation according to the invention;

FIG. 3 shows a cross-section through an impregnation chamber of the illustrative embodiment from FIG. 2;

FIG. 4 shows, diagrammatically, a second illustrative embodiment of the impregnation installation according to the invention.

### DETAILED DESCRIPTION

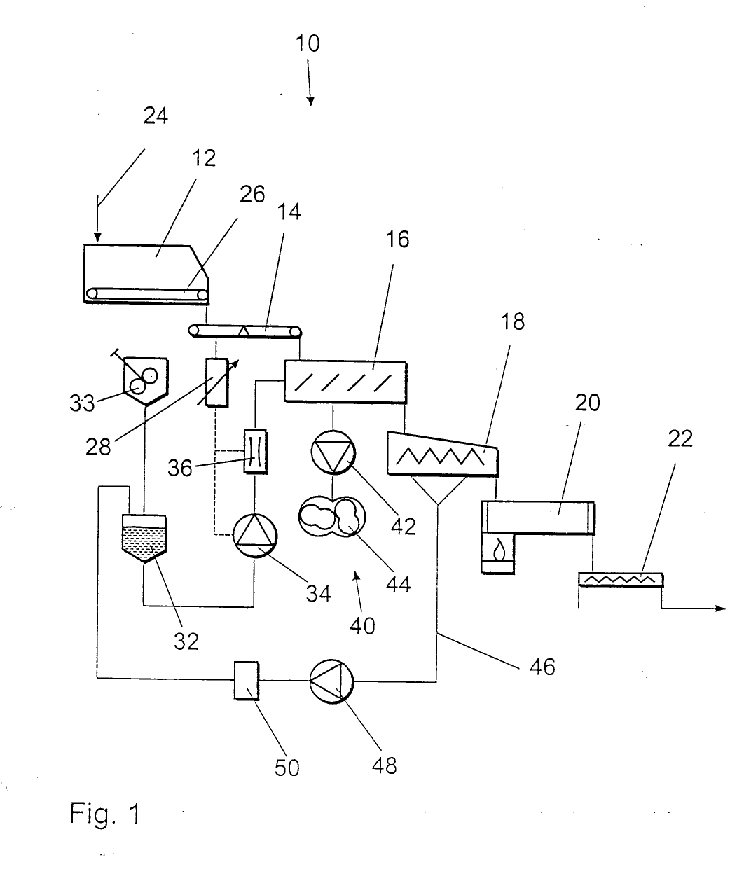

The impregnating plant 10 shown in FIG. 1 comprises a metering bunker 12, a conveyor-type weigher 14 connected thereto in the process direction, downstream of which, in turn, there is a vacuum impregnation installation 16 according to the invention. A dewatering screw 18 is arranged further in the process direction, downstream of which there is a dryer 20 and beyond this a downstream reciprocating screw 22.

Particulate material to be impregnated, for example, dry straw with a moisture content of 20-25% and a bulk density of approximately 45 kg/m³, is charged into the metering bunker 12 (symbolised by an arrow 24) from a reservoir, which is not shown, or directly from a chipper or chopper, which is not shown. The metering bunker 12 transfers the material by means of a conveyor belt 26 to the conveyor-type weigher 14, from where the material is fed to the vacuum impregnation installation 16. The weight of the material charged is determined on the conveyor-type weigher 14. On the basis of the weight determined, the conveyor speed of the conveyor belt 26 and/or of the conveyor-type weigher 14 can be changed by means of a control 28, so that the volume stream transferred from the conveyor-type weigher to the vacuum impregnation installation 16 essentially retains a constant predetermined value. It is pointed out at this point that a volume determination is also possible instead of weighing.

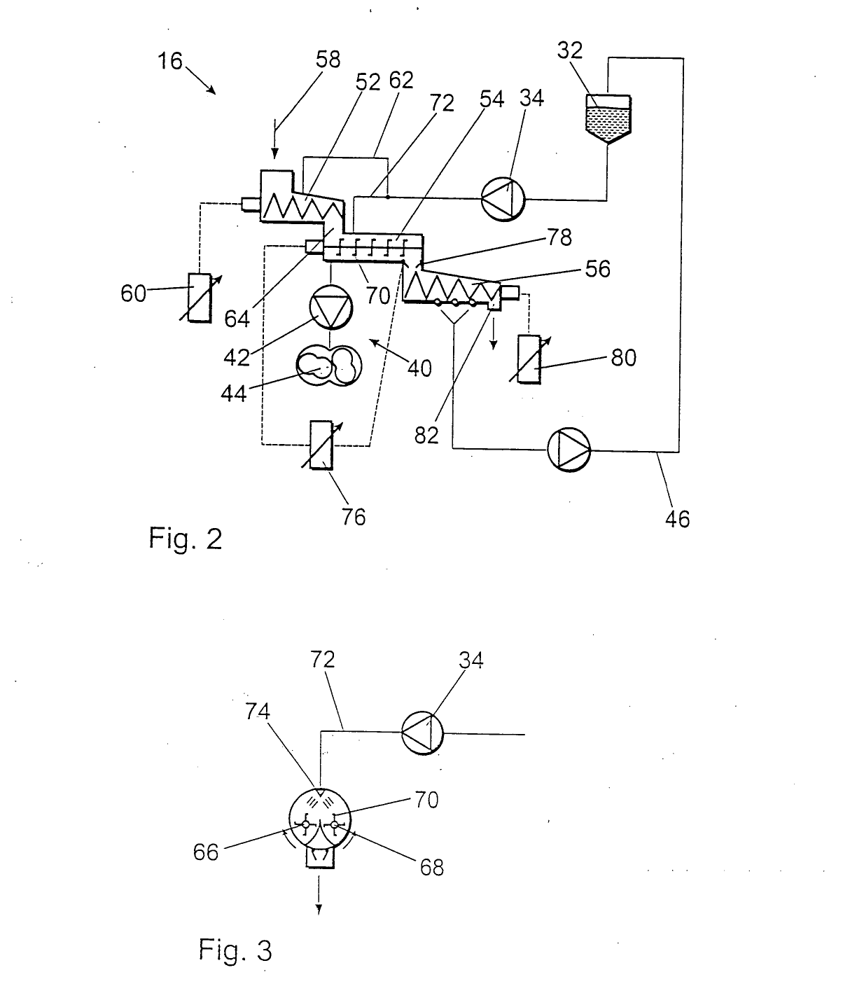

A view on the mode of operation of the impregnation installation and, in particular, with regard to the aspect of the improvement in the sealing characteristics by (pre)treatment of the material to be impregnated will be given separately with reference to FIGS. 2 to 4.

The vacuum impregnation installation 16 is connected to an impregnating agent feed device. This essentially consists of an impregnating solution reservoir 32, a measurement and control unit 33 for measuring and metering the impregnating solution concentration, a controllable metering pump 34 and a flow meter 36. Both the metering pump 34 and the flow meter 36 are connected to the control 28 (SPS control) and can be set to a predetermined throughput of, for example 35% (m/m) or 35% (V/V) depending on the volume or mass flow of the (dry) material (absolutely dry material) transferred from the conveyor-type weigher 14, which volume or mass flow is likewise controlled by the control 28. The throughput can be controlled in respect of the volume or also of the weight of the impregnating agent solution, i.e. depending on the density and thus the concentration of the solution. In this way it is ensured that the amount of impregnating solution or impregnating agent required at a particular point in time is always ready for impregnating, as a result of which the consumption of impregnating agents by the plant can be reduced.

The impregnation installation 16 is furthermore connected to a vacuum system 40. The vacuum system 40 has a control valve 42 and one or more vacuum pumps 44 connected in series. Vacuum pumps 44 that can be used are, for example, rotary vane pumps, Roots pumps, liquid-ring pumps or combinations of such pumps and optionally also combinations with ballast tanks. The vacuum generated in the impregnation installation can be automatically or manually adjusted to a preselected pressure range of, for example, 10-50 mbar and preferably 25 mbar by means of the control valve 42. For this purpose (a) a pressure meter, which is not shown and which records the pressure in the impregnation chamber, and (b) a control, which likewise is not shown, are required, which control actuates the control valve depending on the recorded and the preselected pressure/pressure range and, in this way, connects the impregnation chamber to the vacuum pumps or disconnects it from the latter, as desired. The design of the vacuum pump(s) depends on the leakage losses of the impregnation installation that are to be expected.

After impregnation the material impregnated in the impregnation installation 16 is transferred to the dewatering screw 18. This is present constructed (sic) as a conveyor screw conically tapered in the transport direction. It has orifices for dewatering (not shown) around its circumference, essentially in the region of plug formation, through which orifices the excess impregnating agent adhering to the impregnated material is able to flow away on compression. After dewatering, the impregnating agent is collected and fed via a return line 46 with a control valve 48 and a filter 50 into the reservoir 32. As a result of the immediate dewatering, collection and the continuous return of excess impregnating agent, the consumption of impregnating agent is further reduced.

Depending on the amount and the concentration of the returned impregnating solution, the concentration of the impregnating solution in the reservoir 32 also changes. The desired concentration (for example, of a 25% aqueous solution) is restored by means of the measurement and control unit 33 for metering the impregnating solution concentration by an automatically controlled addition of water or solvent and/or of the impregnating agent substance(s) to be dissolved. Overall, it is thus ensured that a predetermined amount of impregnating agent is added to a specific amount of material to be impregnated.

The impregnated and dewatered material, that is to say straw in the example mentioned initially, is passed on—now with a moisture content of 120-160% and a bulk density of approximately 200 kg/m³—from the dewatering screw 18 to the dryer 20. In the dryer it is freed from the residual water from the impregnating solution down to a desired residual moisture content by heating. The dryer here is, for example, a drum dryer in which the material is brought into motion by rotation of a drum and in this way is well ventilated and, at the same time, transported towards an outlet orifice of the drum dryer. The material is transferred from the dryer 20 to a (reciprocating) transport screw 22. From the latter the impregnated and dried material is passed on to the subsequent treatment processes, such as, for example, to the shredding unit.

The vacuum impregnation installation 16 is shown in the form of a first illustrative embodiment in FIG. 2. It has a feed screw 52, a vacuum impregnation chamber 54 flanged thereto and a discharge screw 56, which, in turn, is flanged to the vacuum impregnation chamber. Both the feed screw 52 and the discharge screw 56 are constructed as stuffing screws conically tapered in the direction of transport. The vacuum impregnation chamber 54 has a mixer, which will be explained in more detail with reference to FIG. 3. The straw transferred from the conveyor-type weigher 14 (c.f. FIG. 1) initially passes into the feed screw 52 at the input side, for example under the influence of gravity (arrow 58). This screw transports it at a preset speed towards its axial end tapered at the output side. The transport speed is set via the speed of revolution of the conveyor screw by means of a control 60 in such a way that, taking account of the amount of material fed from the conveyor-type weigher, it is always ensured that the material in the region of the tapered output side end of the screw forms a plug.

Impregnating agent solution is already added to the material in the feed screw 52 via a first feed line 62, in order to improve the sealing characteristics of the material in the region of the output side end of the feed screw 52 and in order, at the same time, to pre-impregnate the material under the pressure exerted by the feed screw 52. In addition, or as an alternative, a liquid that does not contain any impregnating agent but improves the sealing characteristics of the material within the feed screw 52 can be added to the material via a separate feed line, which is not shown in FIG. 2.

The output side end of the feed screw 52 at the same time forms an inlet orifice 64, through which the material is transferred into the impregnation chamber 54. The impregnation chamber 54, which is designed as a continuous mixer, has two shafts 66, 68 provided with a multiplicity of (adjustable) mixing tools 70, c.f. FIG. 3, which loosen the material by rotating in opposite directions, mix it thoroughly with the impregnating agent and, at the same time, transport it towards the discharge screw 56.

The impregnation chamber 54 is connected to the vacuum system 40 (c.f. also FIG. 1) and a vacuum down to a desired pressure of, for example, 25 mbar is applied with the aid of the control valve 42, depending on the pumping capacity of the vacuum pumps 44. As a result of the reduced pressure the material introduced is degassed to an adequate extent, in order to ensure a better absorption capacity for the impregnating agent added subsequently or at the same time. Here the design of the vacuum pump(s) depends on the leakage losses to be expected from the impregnation installation. The leakage losses, in turn, are determined by (a) the cross-sections of the inlet orifice and of the outlet orifice of the impregnation installation and (b) the sealing characteristics of the material.

Impregnating agent in the form of the impregnating solution is also introduced into the impregnation chamber 54 via a second feed line 72 during impregnation. This is effected in that the solution is sprayed into the impregnation chamber 54 by means of a nozzle 74 via the continuous mixer and the mixed material contained therein. The amount of impregnating solution added in total, some of which is injected into the feed screw 52 and some of which is injected into the impregnation chamber 54, is restricted by the metering pump 34 and the flow meter 36 (not shown here, c.f. in this regard FIG. 1) to the amount required depending on the volume flow of the material to be impregnated that has been introduced. The embodiment of a horizontally arranged impregnation chamber shown in FIG. 2 is preferably used for low impregnation contents.

The mixing time and mixing intensity in the impregnation chamber 54 can be controlled by means of a further control 76 (frequency converter) that controls the speed of revolution of the shafts 66, 68 in combination with outlet valves arranged at the outlet side end of the impregnation chamber 54. In this way it is possible to increase the mixing intensity in that the speed of revolution of the shafts 66, 68 is set higher, without shortening the mixing time, in that the outlet valves 78 remain closed for as long as desired and/or are closed as far as desired. In this way the material is, on the one hand, transported more rapidly to the output side end of the impregnation chamber 54, but stays there for a correspondingly longer time, in order, for example, to be subjected to longer degassing after impregnation. The outlet valves can furthermore be controlled depending on the power consumption of a drive motor (not shown) for the shafts 66, 68, in order, for example, to prevent a back-up of material. If a lower speed of revolution of the shaft is chosen, the residence time of the material in the impregnation chamber as a whole and in particular below the injection nozzle 74 can be prolonged by reason of a lower transport speed.

The injection nozzle is preferably arranged in the initial region close to the inlet orifice of the impregnation chamber. However, depending on the impregnating process, it can also be arranged close to the centre of the impregnation chamber, in order, for example, to prolong the period for degassing of the material before impregnation.

The dispersion of the impregnating agent solution in respect of the portion injected into the feed screw 52 and the portion injected into the impregnation chamber 54 can, for example, be adjusted by means of flow meters and/or valves, which are not shown.

The impregnated material is transported by opening the outlet valves 78 in the inlet region of the discharge screw 56, which likewise is tapered towards its outlet orifice. The material is compressed in the discharge screw, once again in the region of the tapered output side end, which at the same time forms an outlet orifice 82 for outward transfer of the impregnated material from the impregnation installation 16, in such a way that it forms a plug that seals the outlet orifice 82. A control 80, which controls the speed of revolution of the discharge screw 56 depending on the volume stream of the impregnated material—which volume stream is discontinuous with alternately opened and closed or partially closed outlet valves 78—ensures that this is guaranteed. During this operation the screw fulfils a dual function: specifically, during plug formation excess impregnating agent is pressed out in the manner described above and fed to the reservoir 32 via the return line 46. By pressing out excess impregnating agent the total proportion of impregnating agent required is kept substantially constant depending on the volume stream of the material.

The two plugs in the region of the inlet orifice 64 of the impregnation chamber 54 and of the outlet orifice 82 of the discharge screw 56 have the effect that the material is exposed to the vacuum generated by means of the vacuum system 40 in the entire region between the two plugs. During this exposure it passes, within the vacuum, both through a section (below the injection nozzle) in which the impregnating agent is applied and through a section in which no further impregnating agent is applied but in which the material is only further mixed and/or transported to degas it and to achieve overall a best possible penetration of the impregnating agent into the material.

The impregnated material that is transferred out through the outlet orifice 82 of the discharge screw 56 is fed to the downstream dewatering screw 18, c.f. FIG. 1. However, if there is adequate dewatering in the discharge screw 56, a downstream, additional dewatering screw 18 can also be dispensed with, so that the material is fed directly from the impregnation installation 16 into a downstream dryer 20.

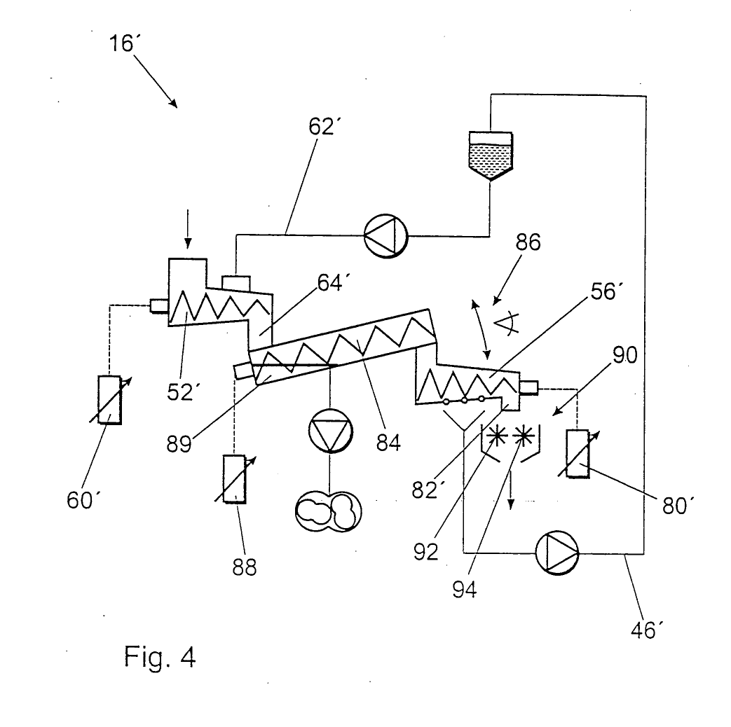

The illustrative embodiment of the vacuum impregnation installation 16′ according to the invention shown in FIG. 4 also has a feed screw 52′ and a discharge screw 56′, which are constructed as conically tapered stuffing screws. However, in contrast to the illustrative embodiment shown above, here the impregnation chamber 84 arranged between the two stuffing screws is constructed as a large volume mixing screw. The impregnation chamber 84 has been tilted from the horizontal such that it ascends in the process direction. The impregnation installation 16′ also differs from the impregnation installation 16 according to FIG. 1 in that the entire amount of impregnating agent is introduced into the feed screw 52′ via the line 62′ and no further line for the direct injection of impregnating agent into the impregnation chamber 84 is provided.

The mixing screw used for vacuum impregnation is equipped with two control mechanisms in order to achieve the desired mixing time and mixing intensity. On the one hand, an adjustment device (indicated by arrow 86) is provided by means of which the inclination of the impregnation chamber with respect to the horizontal can be adjusted and, on the other hand, a speed of revolution control 88 for adjusting the conveyor speed of the mixing screw is provided.

The impregnating agent injected via the feed screw 52′ is transferred, together with the material that has now already been pre-impregnated, through the inlet orifice 64′ into the impregnation chamber and collects in the latter in a bottom section 98. Depending on the inclination of the impregnation chamber 84, the speed of revolution of the mixing screw and the amount of impregnating agent fed in, the material comes into contact with the impregnating agent for a prolonged mixing time. This type of dip bath impregnation is particularly suitable for higher impregnation contents.

In the direction of transport at the end of the mixing screw of the impregnation chamber 84, the impregnated material is transferred to the discharge screw 56′, which, on the one hand, compresses the material as in the illustrative embodiment mentioned above and in so doing presses out excess impregnating agent and which, on the other hand, at the same time forms a material plug in the region of the outlet orifice 82′ for outward transfer of the material from the impregnation installation 16′. Here again, the material plug in the inlet orifice 64′ and the material plug in the outlet orifice 82′ delimit the volume placed under vacuum by means of the vacuum system 40′.

The impregnated material is transferred from the discharge screw 56′ to a loosening unit 90, which essentially has two needle rollers 92, 94, with which the impregnated, partially agglomerated material is loosened after outward transfer before it, for example—insofar as a downstream dewatering screw is not provided—is transferred to a dryer (c.f. FIG. 1). A similar loosening unit can also be provided downstream of the inlet orifice within the impregnation chamber 84 for loosening the material after inward transfer.

The speeds of revolution of the feed screw, the discharge screw 52′, 56′ (sic) and of the mixing screw and the inclination of the impregnation chamber 84 are controlled by means of controls 60′, 80′, 86 and 88.

All controls of the illustrative embodiments shown can be linked to one another and in particular also to the other controls of the impregnation plant 10 (c.f. FIG. 1) via a computer, so that the impregnation process proceeds fully automatically. It furthermore proves advantageous to provide further measurement and control circuits with which, for example, the pressure or the change in pressure in impregnation chamber 54 or 84 is monitored and the particular measured value is used to so change the speed of revolution of the feed screw and discharge screw depending on the amount of material and impregnating agent to be charged that maximum possible vacuum sealing is ensured.

In addition to the illustrative embodiments shown, yet further embodiments of the impregnation chamber are possible. For example, this can have a rotary drum with adjustable or fixed paddles for mixing the material and the impregnating agent. It can furthermore also have a chain conveyor or a paddle transport (Redler system).

Now that the invention has been described,

1. A method for vacuum impregnation of particulate material in an impregnation installation (16, 16′) which has an impregnation chamber (54, 84) that can be placed under vacuum, an inlet orifice (64, 64′) for transferring the material into the impregnation chamber (54, 84) and an outlet orifice (82, 82′) for transferring the material out of the impregnation installation (16, 16′), said method comprising:
treating the material with a substance in order thus to produce a treated material, the sealing characteristics of which in a stuffing screw (52) are improved in comparison with the untreated material,
transporting the treated material by means of said stuffing screw (52) to the inlet orifice (64, 64′),
transferring the treated material by means of the stuffing screw (52) through the inlet orifice (64, 64′) into the impregnation chamber (54, 84), so that the treated material seals the inlet orifice (64, 64′) during inward transfer,
impregnating the material in the impregnation chamber (54, 84) with an impregnating agent under reduced pressure,
transporting the impregnated material to the outlet orifice (82, 82′) and
transferring outward the impregnated material from the impregnation installation (16, 16′) through the outlet orifice (82, 82′), so that the material seals the outlet orifice (82, 82′) during outward transfer.

2. The impregnation method according to claim 1, wherein the substance with which the material is treated in order to produce a treated material, the sealing characteristics of which in said stuffing screw are improved compared with the untreated material, is a liquid impregnating agent.

3. The impregnation method according to claim 1, futher comprising continuously transferring the material through the inlet orifice (64, 64′) into the impregnation chamber (54, 84) and/or continuously transferring the material through the outlet orifice (82, 82′) out of the impregnation installation (16, 16′).

4. The impregnation method according to claim 1, further comprising compressing the material during transport to the outlet orifice (82, 82′).

5. The impregnation method according to claim 4, further comprising compressing the material during transport to the outlet orifice (82, 82′) and collecting excess impregnating agent during this operation.

6. The impregnation method according to claim 1, further comprising loosening the material after inward transfer and/or outward transfer.

7. The impregnation method according to one claim 1, wherein the amount of the material transported to the inlet orifice (64, 64′) and outlet orifice (82, 82′) is controlled in order to influence the sealing characteristics of the material.

8. The impregnation method according to claim 1, further comprising introducing additional impregnating agent into the impregnation chamber (54, 84) during impregnation.

9. The impregnation method according to claim 2, wherein the amount of the impregnating agent used upstream of the inlet into the impregnation chamber (54, 84) and/or of the impregnating agent additionally used during impregnation is controlled depending on the amount of the untreated material transported to the inlet orifice (64, 64′) in order to influence the sealing characteristics of the material and/or the impregnation thereof.

10. The impregnation method according to claim 1, wherein the impregnation chamber (54, 84) is permanently placed under vacuum.

11. An installation for carrying out the method according to claim 1.

12. An installation for the vacuum impregnation of particulate material said installation comprising an impregnation chamber (54, 84) that can be placed under vacuum, an inlet orifice (64, 64′) for transfer of the material into the impregnation chamber (54, 84) and an outlet orifice (82, 82′) for transfer of the material out of the impregnation installation (16, 16′), with a stuffing screw (52, 52′) for transporting the material to the inlet orifice (64, 64′), with a device (62, 62′), which is assigned to the stuffing screw or is upstream, for treatment of the particulate material with a substance in order thus to produce a treated material, the sealing characteristics of which in the stuffing screw (52, 52′) are improved compared with the untreated material, with means for transporting impregnated material to the outlet orifice (82, 82′) and with a device (40, 40′) for applying a vacuum to the impregnation chamber (54, 84).

13. The installation according to claim 12, wherein the stuffing screw (52, 52′) and the means for transporting the impregnated material to the outlet orifice (82, 82′) are so constructed that the material seals the inlet orifice (64, 64′) at least essentially pressure-tight on inward transfer into the impregnation chamber (54, 84) and seals the outlet orifice (82, 82′) at least essentially pressure-tight on outward transfer out of the impregnation installation (16, 16′).

14. The installation according to claim 13, wherein the means for transporting the impregnated material to the outlet orifice (82, 82′) is designed to compress the material.

15. The installation according to claim 14, wherein the means for transporting the impregnated material to the outlet orifice (82, 82′) comprises a stuffing screw (56).

16. The installation according to claim 12, wherein the installation has a control (60, 60′, 80, 80′) for controlling the speed of revolution of one or more of the stuffing screws (52, 52′, 56, 56′) present.

17. The installation according to claim 12, wherein the device (62, 62′) that is assigned to the stuffing screw or arranged upstream, for treatment of the particulate material, is equipped to add to the material a liquid impregnating agent and/or a liquid agent that improves the sealing characteristics of the particulate material.

18. The installation according to claim 15, wherein in the region of the stuffing screw (56, 56′) for transporting the material to the outlet orifice (discharge screw), the installation has a device (46, 46′) for collecting and returning excess impregnating agent.

19. The installation according to claim 15, wherein the installation has means (90) for loosening the material after inward transfer and/or outward transfer, which means are downstream of the feed screw (52, 52′) and/or the discharge screw (56, 56′).

20. The installation according to claim 12, wherein the installation has means (62, 62′, 72) for adding impregnating agent in the impregnation chamber (54, 84).

21. The installation according to claim 20, wherein the installation has a control (28, 34, 36) for controlling the addition of impregnating agent, in particular depending on the speed of revolution of the stuffing screws (52, 52′, 56, 56′).
